(19) United States
(12) Patent Application Publication
(10) Pub. No.: US 2004/0045633 A1
(43) Pub. Date: Mar. 11, 2004

(54) Intermediate product, method and device for producing wood chips

(76) Inventor: Robert Loth, Lage-Mussen (DE)

Correspondence Address: Charles NJ Ruggiero, Ohlandt Greeley Ruggiero & Perle, 10th Floor, One Landmark Square, Stamford, CT, 06901-2682, US

(21) Appl. No.: 10/432,295

(22) PCT Filed: Oct. 27, 2001
(86) PCT No.: PCT/EP01/12460

(30) Foreign Application Priority Data
Nov. 25, 2000 (DE) 10058626.0

(51) Int. Cl. B27C 1/00

(52) U.S. Cl. 144/174

(57) ABSTRACT

The invention relates to an intermediate product, a method for processing an intermediate product and a wood-chipping device for processing an intermediate product. The intermediate product (20) is substantially rod-shaped and is between one and two times as long as oriented strand (OS) chips. The intermediate product is fed to a wood-chipping device comprising a large number of blades (4), whose cutting edges run at least approximately parallel to the blade ring axis (2) and which enclose a working chamber. The intermediate product is rotated about the blade ring axis and is aligned in such a way that it lies substantially parallel to said ring axis and is pressed by centrifugal force against the cutting edges of the blades.

The invention relates to a method as well as a device for producing wood chips. For this, there are basically two systems, which differ fundamentally from each other and which, accordingly, also produce different products.

The first system relates to so-called direct chippers. In it, uncut round timber is fed into a chute. Arranged parallel to the axis along which the wood is fed is a knife ring, which is equipped along its circumference with a large number of knives. The cutting edges of the knives run parallel to the knife ring. The knife ring can move in such a way that it plunges into the body of the round timber and is able to chip it. See, for example,

DE 2,947,199 C1.

Another design of direct chippers, which belongs to the first system mentioned, has a disk that is mounted so that it can pivot. The disk carries chipping knives on one of its side faces. The round timber or tree stumps are fed to this working face in a direction parallel to the fibers. Because the circumferential speeds of the individual face elements of the working face differ in magnitude, depending on whether the face element lies radially inward or radially outward, the chipping result also differs and this is detrimental to the quality.

The machines mentioned, which belong to the first system, serve, above all, to produce so-called oriented strand (OS) chips. The fibers of these chips are oriented along the lengthwise direction of the chip. The chip is extremely thin. It serves to produce boards of the same name, so-called oriented strand boards (OSB). These are regarded as being of high quality. They have great strength, so that they can be used as construction elements for the construction of prefabricated houses, for example.

The second system mentioned uses so-called knife ring chippers. These consist of a ring or collar that is made up of knives, whose cutting edges run, at least largely, parallel to the ring axis. The knife ring encloses a working chamber in which the chippings are introduced into a radially inner region through a filling shaft. A rotor spins the chippings radially outward against the inner face of the knife ring and thus against the cutting edges of the knives, where chipping takes place.

The intermediate product that is fed to the chipper consists of appreciably smaller particles, namely, chippings, that were produced beforehand in a chopping process. In quite generalized terms, they have, at least to an approximation, the size of a match box.

The chips that can be produced by a knife ring chipper differ quite fundamentally from the OS chips produced by the first-mentioned category of machines, which operate according to the first-mentioned system. They are essentially pin-shaped and are reminiscent of thin matches. These chips can be processed only into chipboards or particle boards. However, particle boards are of only limited strength and, in particular, they have no special flexural strength. Thus, they cannot be used as construction elements, but instead find application in the furniture industry.

The advantages and drawbacks of machines of the first-mentioned system—direct chippers for producing OS chips—and of the second-mentioned system with the preceding stage for producing chippings and the final result of chips for particle boards can be summarized as follows:

Direct chippers require, in general, fresh wood, that is, tree trunks of, for example, one meter. Although they are capable of producing high-quality OS chips, they have comparatively large dimensions on account of the large dimensions of the intermediate product. Accordingly, it is extremely expensive to purchase them. The investment costs lie between one and three million DM. Accordingly, they also have relatively little flexibility in use.

Chippers, by contrast, are smaller, more flexible, and more advantageous in cost to purchase. However, they are not capable of producing OSB chips, but only the lower-quality matchlike chips for particle boards.

The object of the invention is to present a method or a device that allows so-called fresh wood as well as recycled wood to be used as intermediate product, has appreciably less construction volume than the known direct chippers, therefore requires lower investment costs, and is flexible in use and that is also fundamentally suitable for producing OSB chips.

This object is solved by the independent claims.

The inventor has thus freed himself of a widely held prejudice. He has resorted to the basic features of the knife ring chipper, but has fundamentally changed the conditions surrounding it. This relates, in particular, to the choice of the dimensions of the intermediate product. The latter has a greater first dimension than the dimension perpendicular to it, so that the intermediate product could be referred to as rod-shaped.

With a method in accordance with the invention and a corresponding device, it is now possible to use highly differing intermediate products, namely, both fresh wood of excellent quality and fresh wood of less good quality, such as dwarf timber and branches, as well as recycled wood. Coming into consideration here as recycled wood is, for example, wood packaging, which is very common.

The method and device in accordance with the invention can—as mentioned—produce high-quality OSB chips, but, at the same time, also chips of lesser quality. If different categories of chips are produced, these can be classified by a subsequent classification step.

The invention is explained in more detail on the basis of the drawing. Represented therein individually are the following:

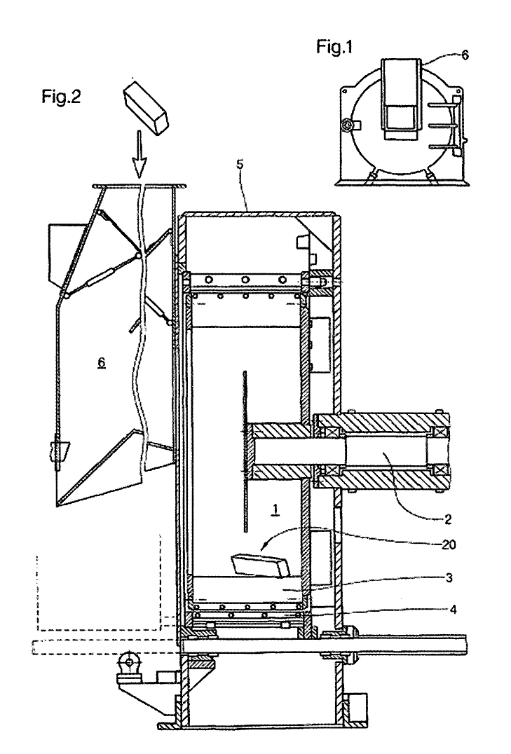

FIG. 1 shows a chipper in a front view, that is, in a view on that side on which the casing cover together with the spout for the intermediate product is situated.

FIG. 2 shows, on an enlarged scale, an axial section of the chipper in accordance with FIG. 1.

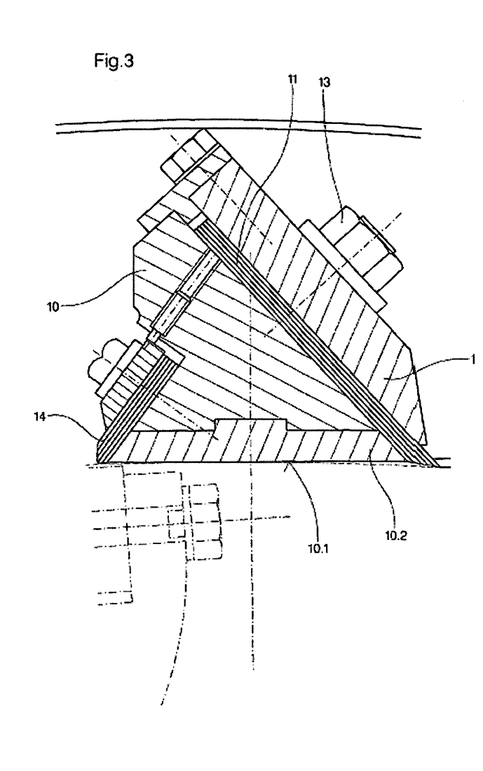

FIG. 3 shows, in an enlarged representation, a section taken from FIG. 2, namely, a knife set.

As seen from FIGS. 1 and 2 individually, the chipper consists of a rotor, which is driven by a shaft 2. The rotor 1 contains a collar of blades 3, which are parallel to the axis. A knife box with knives 4, which are likewise arranged parallel to the axis, surrounds the rotor 1. Rotor 1 and the knife box are, in turn, arranged in a casing 5 and jointly enclosed by it. Casing 5 has a inlet 6 for the chippings that are to be fed in as well as a discharge for the finished chips.

FIG. 2 illustrates a rod-shaped intermediate product 20 at two sites. In the present case, this is delivered as a block in the shape of a regular rectangle. Instead, however, this intermediate product could be of a different shape—for example, it could have irregular peripheral surfaces. It is essential only that this intermediate product 20 be more or less rod-shaped; that is, it has a lengthwise dimension that is greater than the crosswise dimensions in planes running perpendicular to it.

The intermediate product 20 is fed into the shaft-shaped inlet 6—see arrow. It then arrives at the inner chamber that is enclosed by the rotor 1. In doing so, the intermediate product 20 comes to lie—either automatically or by means of a corresponding orienting device—in such a way that it is oriented mainly along the lengthwise axis of the rotor shaft 2 and thus more or less parallel to the knives 4. The intermediate product is of substantial size and particularly of substantial length in comparison with the chippings that are fed to the knife ring chippers that have been commonly used up to now.

In FIGS. 3 and 4, two knife sets are represented in a section perpendicular to the axis. These two knife sets are each a component of the knife ring of the machine.

Each knife set is constructed as follows: A supporting bedplate 10 bears a cutting knife 11, which is attached to the supporting bedplate 10 by means of a clamping plate 12 and a screw 13.

Each supporting bedplate 10 has a wear surface 10.1. It is crucial that these wear surfaces 10.1, which face the machine axis, are nearly flat and thus not concentric, as in the prior art.

In the case of the figure here, the wear surface 10.1 is made up of a wear plate 10.2, which, in turn, is attached to the remaining supporting bedplate 10. In the case of FIG. 4, the wear surface 10.1 is made up of a wear layer that is produced by application of a wear layer, preferably by build-up welding or spraying and subsequent smooth grinding.

In the embodiment in accordance with FIG. 3, a knife with M teeth, 14, is provided, which is attached to the side of the supporting bedplate 10 lying opposite to the cutting knife 11 and which works together with the cutting knife of the neighboring knife set. The embodiment in accordance with FIG. 4 is an embodiment without knives with M teeth.

1. An intermediate product for producing chips by feeding [wood] to a chipper with a plurality of knives, the cutting edges of which run at least approximately parallel to the ring axis and which enclose a working chamber;
1.1 the intermediate product is essentially rod-shaped;
1.2 the intermediate product has a length that lies between one and two times the length of so-called OS chips.

2. The intermediate product in accordance with claim 1, further characterized by a length of 80 to 150 mm.

3. The intermediate product in accordance with claim 1 or 2, further characterized by a width with a magnitude of at least 20 mm.

4. The intermediate product in accordance with one of claims 1 to 3, further characterized by a length that is at least 1.5 times the above magnitude.

5. A method for further processing an intermediate product in accordance with one of claims 1 to 4, characterized by the following features:
5.1 the intermediate product is set in rotation around the ring axis and thereby oriented in such a way that it lies essentially parallel to the ring axis and is pressed against the cutting edges of the knife by centrifugal force.

6. The method in accordance with claim 5, further characterized in that the operating parameters, such as the shape of the knife and the knife angle, are chosen in such a way that they afford a chip thickness of 0.2 to 0.6 mm, preferably 0.2 to 0.4 mm.

7. The method in accordance with either claim 5 or 6, further characterized in that the intermediate product is subjected in each case to a drawing cut.

8. The method in accordance with one of claims 1* to 7, further characterized in that an inspection step precedes the chipping in order to permit only intermediate products of certain dimensions to pass through.

9. The method in accordance with one of claims 1* to 8, further characterized in that a classification step follows the chipping [in order to determine] whether the chips are to be classified according to criteria of their shape or their dimensions or their weight.

10. The method in accordance with one of claims 1* to 9, further characterized in that the intermediate product is chopped fresh wood.

11. The method in accordance with one of claims 1* to 9, further characterized in that the intermediate product is recycled wood.

12. A chipper for further processing of an intermediate product in accordance with one of claims 1 to 4, with a casing, which has a inlet for feeding in the intermediate product, and with a rotor that is enclosed by the casing, as well as with a collar of knives, the cutting edges of which are directed inwards.

13. The chipper in accordance with claim 12, further characterized in that the rotor is equipped with blades that are tilted toward the rotor axis.

14. The chipper in accordance with claim 13, further characterized in that the blades of the rotor have limited mobility in the circumferential direction.

15. The chipper system in accordance with one of claims 13 or 14, further characterized in that the blades of the rotor are suspended on a radially inward site in such a way that they can swing.

16. The chipper system in accordance with one of claims 13 to 15, further characterized in that the rotor blades are curved or bent at a right angle.

17. The chipper system in accordance with one of claims 13 to 16, further characterized in that the parameters of the knife, such as the knife angle, the clearance angle, and the set angle, are chosen in such a way that processing of the intermediate product occurs in a paring manner.

18. The chipper system in accordance with one of claims 13 to 17, further characterized in that the circumferential distance between two neighboring rotor blades is two to three times the length of an intermediate product.

19. The chipper system in accordance with one of claims 13 to 18, further characterized in that the axial dimension of the knife ring of the chipper is one to three times the length of the intermediate product.

20. The chipper system in accordance with one of claims 13 to 19, further characterized in that an orienting device is arranged before the working chamber in order to feed in the intermediate product, at least for the most part, parallel to the ring axis.
